(19) United States
(12) Patent Application Publication
(10) Pub. No.: US 2023/0177821 A1
(43) Pub. Date: Jun. 8, 2023

(54) DOCUMENT IMAGE UNDERSTANDING

(71) Applicant: BEIJING BAIDU NETCOM SCIENCE TECHNOLOGY CO., LTD., BEIJING (CN)

(72) Inventors: Qiming PENG, Beijing (CN); Bin LUO, Beijing (CN); Yuhui CAO, Beijing (CN); Shikun FENG, Beijing (CN); Yongfeng CHEN, Beijing (CN)

(21) Appl. No.: 18/063,564

(22) Filed: Dec. 8, 2022

(30) Foreign Application Priority Data
Dec. 8, 2021 (CN) 2021114935762

(51) Int. Cl. G06V 10/82; G06V 30/19; G06V 30/14

(52) U.S. Cl. CPC G06V 10/82; G06V 30/19147; G06V 30/1444

(57) ABSTRACT

A neural network training method and a document image understanding method is provided. The neural network training method includes: acquiring text comprehensive features of a plurality of first texts in an original image; replacing at least one original region in the original image to obtain a sample image including a plurality of first regions and a ground truth label for indicating whether each first region is a replaced region; acquiring image comprehensive features of the plurality of first regions; inputting the text comprehensive features of the plurality of first texts and the image comprehensive features of the plurality of first regions into a neural network model together to obtain text representation features of the plurality of first texts; determining a predicted label based on the text representation features of the plurality of first texts; and training the neural network model based on the ground truth label and the predicted label.

### CROSS-REFERENCE TO RELATED APPLICATION(S)

This application claims priority to Chinese Patent Application No. 202111493576.2, filed on Dec. 8, 2021, the entirety of which is hereby incorporated by reference.

### BACKGROUND

Artificial intelligence is a subject for studying to enable a computer to simulate a certain thought process and intelligent behavior (such as learning, reasoning, thinking and planning) of people, and has both a technology in a hardware level and a technology in a software level. An artificial intelligence hardware technology generally includes technologies such as a sensor, a dedicated artificial intelligence chip, cloud computing, distributed storage and big data processing. An artificial intelligence software technology mainly includes several major directions of a computer vision technology, a speech recognition technology, a natural language processing technology, machine learning/deep learning, a big data processing technology, a knowledge mapping technology, etc.

In recent years, a pre-training technology under a general multimodal scenario has developed rapidly. For a model with both text and image information as input, it is usually necessary to design a corresponding pre-training task to improve interaction of the text and the image information and enhance a capability of the model to handle a downstream task under the multimodal scenario. A common image-text interaction task performs well in a conventional multimodal scenario, but performs poorly in a document scenario where image-text information is highly matched. In this scenario, how to design a more suitable image-text interaction task to enhance the performance capability of the model in the downstream task of the document scenario is a key and difficult problem that needs to be solved urgently.

A technique described in this part is not necessarily a technique that has been conceived or employed previously. Unless otherwise specified, it should not be assumed that any technique described in this part is regarded as the prior art only because it is included in this part. Similarly, unless otherwise specified, a problem mentioned in this part should not be regarded as being publicly known in any prior art.

### Technical Field

The present disclosure relates to the field of artificial intelligence, and specifically relates to a computer vision technology, an image processing technology, a character recognition technology, a natural language processing technology and a deep learning technology, in particular to a training method of a neural network model for document image understanding, a method for document image understanding by utilizing the neural network model, a training apparatus of the neural network model for document image understanding, an apparatus for document image understanding by utilizing the neural network model, an electronic device, a computer-readable storage medium and a computer program product.

### BRIEF SUMMARY

The present disclosure provides a pre-training method of a neural network model for document image understanding, a method for document image understanding by utilizing the neural network model, a training apparatus of the neural network model for document image understanding, an apparatus for document image understanding by utilizing the neural network model, an electronic device, a computer-readable storage medium and a computer program product.

According to one aspect of the present disclosure, a training method of a neural network model for document image understanding is provided. The method includes: acquiring a plurality of first text comprehensive features corresponding to a plurality of first texts in a first original document image, wherein the first text comprehensive features at least represent text content information of the corresponding first texts; determining at least one original image region from among a plurality of original image regions included in the first original document image based on a predetermined rule; replacing the at least one original image region with at least one replacement image region in the first original document image to obtain a first sample document image and a ground truth label, wherein the first sample document image includes a plurality of first image regions, the plurality of first image regions include the at least one replacement image region and at least another original image region that is not replaced among the plurality of original image regions, wherein the ground truth label indicates whether each first image region of the plurality of first image regions is the replacement image region; acquiring a plurality of first image comprehensive features corresponding to the plurality of first image regions, wherein the first image comprehensive features at least represent image content information of the corresponding first image regions; inputting the plurality of first text comprehensive features and the plurality of first image comprehensive features into the neural network model simultaneously to obtain a plurality of first text representation features that correspond to the plurality of first texts and are output by the neural network model, wherein the neural network model is configured to, for each first text in the plurality of first texts, fuse a first text comprehensive feature corresponding to the first text with the plurality of first image comprehensive features so as to generate a first text representation feature corresponding to the first text; determining a predicted label based on the plurality of first text representation features, wherein the predicted label indicates a prediction result of whether each first image region of the plurality of first image regions is the replacement image region; and training the neural network model based on the ground truth label and the predicted label.

According to an aspect of the present disclosure, a training method of a neural network model for document image understanding is provided. The method includes: acquiring a sample document image and a ground truth label, wherein the ground truth label indicates an expected result of executing a target document image understanding task on the sample document image; acquiring a plurality of text comprehensive features corresponding to a plurality of texts in the sample document image, wherein the text comprehensive features at least represent text content information of the corresponding texts; acquiring a plurality of image comprehensive features corresponding to a plurality of image regions in the sample document image, wherein the image comprehensive features at least represent image content information of the corresponding image regions; at least inputting the plurality of text comprehensive features and the plurality of image comprehensive features into the neural network model simultaneously to obtain at least one representation feature output by the neural network model, wherein the neural network model is obtained by training through the above training method; determining a predicted label based on the at least one representation feature, wherein the predicted label indicates an actual result of executing the target document image understanding task on the sample document image; and further training the neural network model based on the ground truth label and the predicted label.

According to an aspect of the present disclosure, a method for document image understanding by utilizing a neural network model is provided. The method includes: acquiring a plurality of text comprehensive features corresponding to a plurality of texts in a document image, wherein the text comprehensive features at least represent text content information of the corresponding texts;

acquiring a plurality of image comprehensive features corresponding to a plurality of image regions in the document image, wherein the image comprehensive features at least represent image content information of the corresponding image regions; at least inputting the plurality of text comprehensive features and the plurality of image comprehensive features into the neural network model simultaneously to obtain at least one representation feature output by the neural network model, wherein the neural network model is obtained by training through the above training method; and determining a document image understanding result based on the at least one representation feature. According to an aspect of the present disclosure, a training apparatus of a neural network model for document image understanding is provided. The apparatus includes: a first acquiring unit, configured to acquire a plurality of first text comprehensive features corresponding to a plurality of first texts in a first original document image, wherein the first text comprehensive features at least represent text content information of the corresponding first texts; a region determining unit, configured to determine at least one original image region from among the plurality of original image regions included in the first original document image based on a predetermined rule; a region replacing unit, configured to replace the at least one original image region with at least one replacement image region in the first original document image to obtain a first sample document image and a ground truth label, wherein the first sample document image includes a plurality of first image regions and the plurality of first image regions include the at least one replacement image region and at least another original image region that is not replaced among the plurality of original image regions, wherein the ground truth label indicates whether each first image region of the plurality of first image regions is the replacement image region; a second acquiring unit, configured to acquire a plurality of first image comprehensive features corresponding to the plurality of first image regions, wherein the first image comprehensive features at least represent image content information of the corresponding first image regions; the neural network model, configured to, for each first text of the plurality of first texts, fuse the received first text comprehensive feature corresponding to the first text with the plurality of received first image comprehensive features so as to generate a first text representation feature corresponding to the first text for outputting; a first predicting unit, configured to determine a predicted label based on the plurality of first text representation features, wherein the predicted label indicates a prediction result of whether each first image region of the plurality of first image regions is the replacement image region; and a first training unit, configured to train the neural network model based on the ground truth label and the predicted label.

According to an aspect of the present disclosure, a training apparatus of a neural network model for document image understanding is provided. The apparatus includes: a third acquiring unit, configured to acquire a sample document image and a ground truth label, wherein the ground truth label indicates an expected result of executing a target document image understanding task on the sample document image; a fourth acquiring unit, configured to acquire a plurality of text comprehensive features corresponding to a plurality of texts in the sample document image, wherein the text comprehensive features at least represent text content information of the corresponding texts; a fifth acquiring unit, configured to acquire a plurality of image comprehensive features corresponding to a plurality of image regions in the sample document image, wherein the image comprehensive features at least represent image content information of the corresponding image regions; the neural network model, configured to generate at least one representation feature for outputting at least based on the plurality of received text comprehensive features and the plurality of received image comprehensive features, wherein the neural network model is obtained by training through the above training apparatus; a second predicting unit, configured to determine a predicted label based on the at least one representation feature, wherein the predicted label indicates an actual result of executing the target document image understanding task on the sample document image; and a second training unit, configured to further train the neural network model based on the ground truth label and the predicted label.

According to an aspect of the present disclosure, an apparatus for document image understanding by utilizing a neural network model is provided. The apparatus includes: a sixth acquiring unit, configured to acquire a plurality of text comprehensive features corresponding to a plurality of texts in a document image, wherein the text comprehensive features at least represent text content information of the corresponding texts; a seventh acquiring unit, configured to acquire a plurality of image comprehensive features corresponding to a plurality of image regions in the document image, wherein the image comprehensive features at least represent image content information of the corresponding image regions; the neural network model, configured to generate at least one representation feature for outputting at least based on the plurality of received text comprehensive features and the plurality of received image comprehensive features, wherein the neural network model is obtained by training through the above training apparatus; and a third predicting unit, configured to determine a document image understanding result based on the at least one representation feature.

According to an aspect of the present disclosure, an electronic device is provided, including: at least one processor; and a memory in communication connection with the at least one processor, wherein the memory stores instructions that are executed by the at least one processor, and these instructions are executed by the at least one processor, such that the at least one processor can execute the above method.

According to an aspect of the present disclosure, a non-transient computer-readable storage medium storing a computer instruction is provided, wherein the computer instruction is configured to cause a computer to execute the above method.

According to an aspect of the present disclosure, a computer program product is provided, including a computer program, wherein the computer program, when executed by a processor, implements the above method.

According to one or more embodiments of the present disclosure, the text features of the texts in the document image and the image features of the plurality of regions of the sample document image obtained by replacing a part of regions in the document image are simultaneously input into the neural network model, the text representation output by the model is used to predict a region where the image and the text do not match, and then the model is trained based on the predicted label and the ground truth label, thereby realizing learning of fine-grained text representation combined with image and text information, enhancing interaction between two modalities of the image and the text at the same time, and further improving performance of the neural network model in a downstream task of a document scenario.

It should be understood that the content described in this part is not intended to identify key or important features of the embodiments of the present disclosure, and is not configured to limit the scope of the present disclosure as well. Other features of the present disclosure will become easily understood through the following specification.

### BRIEF DESCRIPTION OF THE SEVERAL VIEWS OF THE DRAWINGS

Accompanying drawings exemplarily show the embodiments, constitute a part of the specification, and together with text description of the specification, serve to explain example implementations of the embodiments. The shown embodiments are only for the purpose of illustration, and do not limit the scope of the claim. In all the accompanying drawings, the same reference numerals refer to the similar but not necessarily the same elements.

FIG. 1A shows a schematic diagram of an example system in which various methods described herein may be implemented according to an embodiment of the present disclosure;

FIG. 1B shows a schematic diagram of an example neural network model for implementing various methods described herein and upstream and downstream tasks thereof according to an embodiment of the present disclosure;

FIG. 2 shows a flow chart of a training method of a neural network model for document image understanding according to an example embodiment of the present disclosure;

FIG. 3A shows a schematic diagram of a document image according to an example embodiment of the present disclosure;

FIG. 3B shows a schematic diagram of performing text recognition on a document image according to an example embodiment of the present disclosure;

FIG. 3C shows a schematic diagram of replacing a part of image regions of a document image according to an example embodiment of the present disclosure;

FIG. 4 shows a flow chart of acquiring a plurality of first text comprehensive features corresponding to a plurality of first texts in a first original document image according to an example embodiment of the present disclosure;

FIG. 5 shows a flow chart of acquiring a plurality of first image comprehensive features corresponding to a plurality of first image regions according to an example embodiment of the present disclosure;

FIG. 6 shows a flow chart of a training method of a neural network model for document image understanding according to an example embodiment of the present disclosure;

FIG. 7 shows a flow chart of a training method of a neural network model for document image understanding according to an example embodiment of the present disclosure;

FIG. 8 shows a flow chart of a method for document image understanding by utilizing a neural network model according to an example embodiment of the present disclosure;

FIG. 9 shows a structural block diagram of a training apparatus of a neural network model for document image understanding according to an example embodiment of the present disclosure;

FIG. 10 shows a structural block diagram of a training apparatus of a neural network model for document image understanding according to an example embodiment of the present disclosure;

FIG. 11 shows a structural block diagram of an apparatus for document image understanding by utilizing a neural network model according to an example embodiment of the present disclosure; and

FIG. 12 shows a structural block diagram of an example electronic device capable of being configured to implement an embodiment of the present disclosure.

### DETAILED DESCRIPTION

The example embodiment of the present disclosure is illustrated below with reference to the accompanying drawings, including various details of the embodiment of the present disclosure for aiding understanding, and they should be regarded as being only examples. Therefore, those ordinarily skilled in the art should realize that various changes and modifications may be made on the embodiments described here without departing from the scope of the present disclosure. Similarly, for clarity and simplicity, the following description omits description of a publicly known function and structure.

In the present disclosure, unless otherwise noted, describing of various elements by using terms “first”, “second” and the like does not intend to limit a position relationship, a time sequence relationship or an importance relationship of these elements, and this kind of terms is only configured to distinguish one component with another component. In some examples, a first element and a second element may refer to the same instance of this element, while in certain cases, they may also refer to different instances based on the contextual description.

The terms used in description of various examples in the present disclosure are only for the purpose of describing the specific examples, and are not intended to limit. Unless otherwise explicitly indicated in the context, if the quantity of the elements is not limited specially, there may be one or more elements. In addition, the term “and/or” used in the present disclosure covers any one of all possible combination modes in the listed items.

In the related art, a commonly used image-text interaction pre-training task includes a text matching task and image reconstruction. An image-text matching task refers to using a representation feature output by downstream of a model to classify and judge whether an image-text pair input into the model matches, or whether an input text can describe an input picture. Image reconstruction refers to reconstructing an input complete image through an output vector of the downstream of the model.

The image-text matching task uses an image-text-related sample as a positive example, and an image-text-inconsistent sample as a negative example. Inventors recognize that in a document scenario, text content and image content are strongly correlated, it is a very simple task to judge whether an image and a text match, and it is not helpful for interaction of multimodal information; and a graph reconstruction method is very helpful for layout information reconstruction of a document in the document scenario, but it is difficult to reproduce the text content accurately, which makes it difficult for the model to understand a finer-grained relationship between the text and the image.

In the present disclosure, text features of texts in a document image and image features of a plurality of regions of a sample document image obtained by replacing a part of regions in the document image are simultaneously input into a neural network model, text representation output by the model is used to predict a region where the image and the text do not match, and then the model is trained based on a predicted label and a ground truth label, thereby realizing learning of fine-grained text representation combined with image and text information, enhancing interaction between two modalities of the image and the text at the same time, and further improving performance of the neural network model in a downstream task of the document scenario.

The embodiment of the present disclosure will be described below in detail with reference to the accompanying drawings.

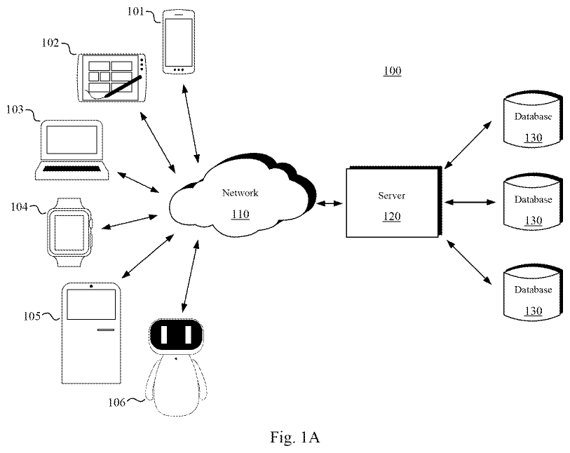

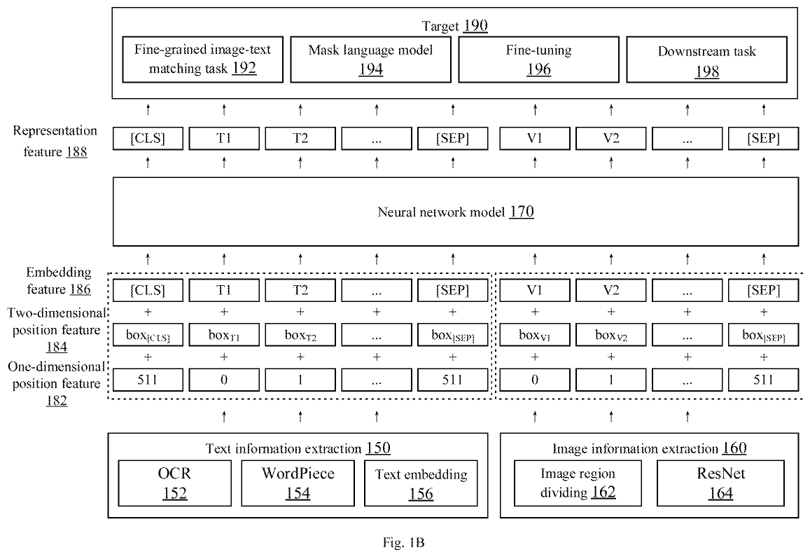

FIG. 1A shows a schematic diagram of an example system 100 in which various methods and apparatuses described herein may be implemented according to an embodiment of the present disclosure. Referring to FIG. 1A, the system 100 includes one or more client devices 101, 102, 103, 104, 105 and 106, a server 120, and one or more communication networks 110 for coupling the one or more client devices to the server 120. The client devices 101, 102, 103, 104, 105 and 106 may be configured to execute one or more application programs.

In certain embodiments of the present disclosure, the server 120 may run one or more services or software applications capable of executing a pre-training method of a neural network model for document image understanding, a fine-tuning training method of the neural network model for document image understanding, or a method for document image understanding by utilizing the neural network model.

In certain embodiments, the server 120 may further provide other services or software applications which may include a non-virtual environment and a virtual environment. In certain embodiments, these services may be provided as web-based services or cloud services, for example, be provided to users of the client devices 101, 102, 103, 104, 105 and/or 106 under a software as a service (SaaS) network.

In configuration shown in FIG. 1A, the server 120 may include one or more components for implementing functions executed by the server 120. These components may include a software component, a hardware component or their combinations capable of being executed by one or more processors. The users operating the client devices 101, 102, 103, 104, 105 and/or 106 may sequentially utilize one or more client application programs to interact with the server 120, so as to utilize services provided by these components. It should be understood that various different system configurations are possible, which may be different from the system 100. Therefore, FIG. 1A is an example of a system for implementing various methods described herein, and is not intended to limit.

The users may use the client devices 101, 102, 103, 104, 105 and/or 106 for document image understanding. The client devices may provide an interface that enables the users of the client devices to interact with the client devices. For example, the users may collect document images by utilizing a client through various input devices, and may also utilize the client to execute the method for document image understanding. The client devices may further output information to the users via the interface. For example, the client may output a result of document image understanding to the users. Although FIG. 1A depicts the six client devices, those skilled in the art may understand that the present disclosure may support any quantity of client devices.

The client devices 101, 102, 103, 104, 105 and/or 106 may include various types of computer devices, such as a portable handheld device, a general-purpose computer (such as a personal computer and a laptop computer), a workstation computer, a wearable device, an intelligent screen device, a self-service terminal device, a service robot, a game system, a thin client, various message transceiving devices, a sensor or other sensing devices, etc. These computer devices may run various types and versions of software application programs and operating systems, such as MICROSOFT Windows, APPLE iOS, a UNIX-like operating system, Linux or Linux-like operating system (such as GOOGLE Chrome OS); or include various mobile operating systems, such as MICROSOFT Windows Mobile OS, iOS, Windows Phone, and Android. The portable handheld device may include a cellular phone, an intelligent telephone, a tablet computer, a personal digital assistant (PDA), etc. The wearable device may include a head-mounted display (such as smart glasses) and other devices. The game system may include various handheld game devices, a game device supporting Internet, etc. The client devices can execute various different application programs, such as various Internet-related application programs, a communication application program (such as an electronic mail application program), and a short message service (SMS) application program, and may use various communication protocols.

A network 110 may be any type of network well known by those skilled in the art, and it may use any one of various available protocols (including but not limited to TCP/IP, SNA, IPX, etc.) to support data communication. As an example only, the one or more networks 110 may be a local area network (LAN), an Ethernet-based network, a Token-Ring, a wide area network (WAN), an Internet, a virtual network, a virtual private network (VPN), an intranet, an extranet, a public switched telephone network (PSTN), an Infrared network, a wireless network (such as Bluetooth and WIFI), and/or any combination of these and/or other networks.

The server 120 may include one or more general-purpose computers, dedicated server computers (such as personal computer (PC) servers, UNIX servers, and midrange servers), blade servers, mainframe computers, server clusters or any other proper arrangements and/or combinations. The server 120 may include one or more virtual machines running a virtual operating system, or other computing architectures involving virtualization (such as one or more flexible pools of a logic storage device capable of being virtualized so as to maintain a virtual storage device of the server). In various embodiments, the server 120 may run one or more service or software applications providing the functions described hereunder.

A computing unit in the server 120 may run one or more operating systems including any above operating system and any commercially available server operating system. The server 120 may further run any one of various additional server application programs and/or a middle tier application program, including an HTTP server, an FTP server, a CGI server, a JAVA server, a database server, etc.

In some implementations, the server 120 may include one or more application programs, so as to analyze and merge data feed and/or event update received from the users of the client devices 101, 102, 103, 104, 105 and 106. The server 120 may further include one or more application programs, so as to display the data feed and/or a real-time event via one or more display devices of the client devices 101, 102, 103, 104, 105 and 106.

In some implementations, the server 120 may be a server of a distributed system, or a server in combination with a distributed system, e.g., a blockchain network. The server 120 may also be a cloud server, or an intelligent cloud computing server or an intelligent cloud host with an artificial intelligence technology. The cloud server is a hosting product in a cloud computing service system, so as to solve the defects of large management difficulty and weak business scalability in a service of a traditional physical host and a Virtual Private Server (VPS).

The system 100 may further include one or more databases 130. In certain embodiments, these databases may be configured to store data and other information. For example, one or more of the databases 130 may be configured to store information such as an audio file and a video file. A data repository 130 may be resident at various positions. For example, the data repository used by the server 120 may be locally resident at the server 120, or may be away from the server 120 and may be in communication with the server 120 via network-based or dedicated connection. The data repository 130 may be of different types. In certain embodiments, the data repository used by the server 120 may be a database, such as a relational database. One or more of these databases may store, update and retrieve data to the database and from the database in response to a command.

In certain embodiments, one or more of the databases 130 may further be used by the application program to store application program data. The database used by the application program may be different types of databases, such as a key value memory pool, an object memory pool, or a conventional memory pool supported by a file system.

The system 100 in FIG. 1A may be configured and operated in various modes, so as to be capable of applying various methods and apparatuses described according to the present disclosure.

FIG. 1B shows a schematic diagram of an example neural network model 170 for implementing various methods described herein and upstream and downstream tasks thereof according to an embodiment of the present disclosure. Referring to FIG. 1B, at upstream of the neural network model 170, by executing text information extraction 150 and image information extraction 160, respective features of an text and an image for being input into a neural network can be obtained, while at downstream of the neural network model, the neural network model 170 may be trained according to different tasks in a target 190 or a document image understanding result may be obtained.

Document information extraction 150 may include three subtasks of optical character recognition (OCR) 152, word segmentation algorithm WordPiece 154, and text embedding 156. By sequentially executing these three subtasks on a document image, text features of each text in the document image can be extracted for being input into the neural network model 170. In some embodiments, the text features may include an embedding feature 186 representing text content information, as well as a one-dimensional position feature 182 and a two-dimensional position feature 184 representing text position information. In one example embodiment, the one-dimensional position feature may indicate a reading order of the text, and the two-dimensional position feature may be information such as a position, shape, and size of a bounding box surrounding the text. Although FIG. 1B only describes the above three subtasks of text information extraction, those skilled in the art may further use other methods or combination of the methods to execute text information extraction.

Image information extraction 160 may include image region division 162 and image coding network ResNet 164. Image region division 162 can divide the document image into a plurality of image regions, while an image feature of each image region can be extracted by using the ResNet 164 for being input into the neural network model 170. In some examples, the text features may include an embedding feature 186 representing image content information, as well as a one-dimensional position feature 182 and a two-dimensional position feature 184 representing image position information. In one example embodiment, the one-dimensional position feature may indicate a reading order of the image regions, and the two-dimensional position feature may be information such as a position, shape, and size of the image regions. It should be understood that the ResNet 164 is only an example of image information extraction, and those skilled in the art may further use other image coding networks or use other methods or combination of the methods to execute image feature extraction.

In input of the neural network model 170, in addition to features related to the text and the image, features based on special symbols may further be included. The special symbols may, for example, include: a classification symbol [CLS] that is located before start of input and whose corresponding output can be used as comprehensive representation of all features, a segmentation symbol [SEP] representing that the same group or type of features have been input completely, a mask symbol [MASK] configured to hide part of input information, an unknown symbol [UNK] representing unknown input, etc. These symbols may be embedded, and corresponding one-dimensional position feature and two-dimensional position feature can be designed for these symbols to obtain a feature of each symbol for being input into the neural network model 170. In one example embodiment, the one-dimensional position feature 182, the two-dimensional position feature 184, and the embedding feature 186 corresponding to each input of the neural network model 170 are directly added to obtain an input feature for being input into the neural network model.

The neural network model 170 may be constructed by using one or more series-connected Transformer structures (Transformer encoders). For each input, the neural network model 170 fuses the input information with all input information by utilizing an attention mechanism to obtain a representation feature 188 of multimodal image-text information. It should be understood that the Transformer structure is an example implemented by an underlying of the neural network model 170 and is not intended to limit.

The target 190 is a task that may be executed by utilizing the representation feature 188 output by the neural network model, and includes a fine-grained image-text matching task 192, a mask language model 194, fine-tuning 196, and a downstream task 198 for document image understanding. It should be noted that these tasks may receive partial features of the representation feature 188. In one example, the fine-grained image-text matching task 192 may only receive text-related representation features (i.e., all representation features from T1 up to the first [SEP], excluding [SEP]), and predict which image regions in the sample image are replaced based on these features. The tasks 192, 194, 196, 198 will be described in detail thereinafter. It may be understood that although FIG. 1B only depicts the four kinds of tasks, those skilled in the art may design the target according to their own needs, and complete the target by utilizing the neural network model 170.

The various neural network models, upstream and downstream tasks, input/output features in FIG. 1B may be configured and operated in various ways to enable the application of various methods and apparatuses described according to the present disclosure.

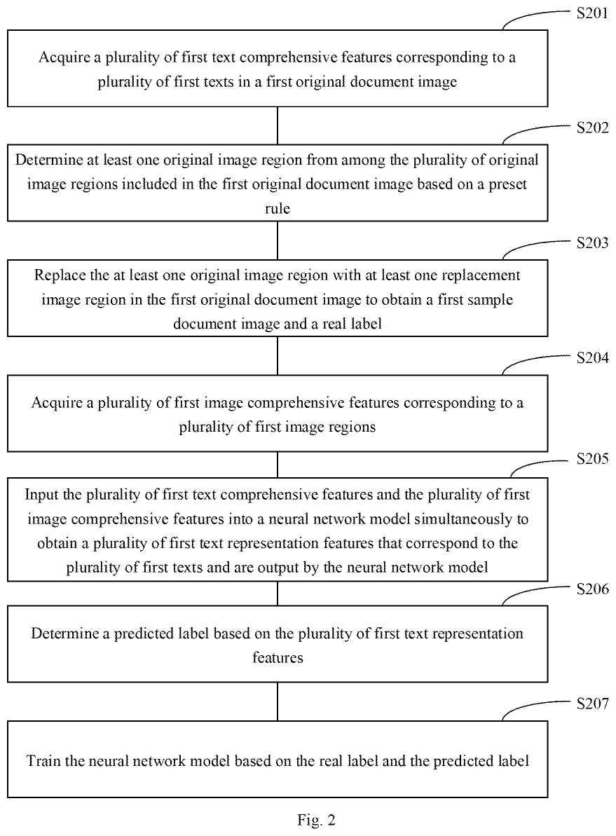

According to one aspect of the present disclosure, a training method of a neural network model for document image understanding is provided. As shown in FIG. 2, the method includes: step S201, a plurality of first text comprehensive features corresponding to a plurality of first texts in a first original document image is acquired, wherein the first text comprehensive features at least represent text content information of the corresponding first texts; step S202, at least one original image region is determined from among the a plurality of original image regions included in the first original document image based on a predetermined rule; step S203, the at least one original image region is replaced with at least one replacement image region in the first original document image to obtain a first sample document image and a ground truth label, wherein the first sample document image includes a plurality of first image regions, the plurality of first image regions include the at least one replacement image region and at least another original image region that is not replaced among the plurality of original image regions, wherein the ground truth label indicates whether each first image region of the plurality of first image regions is the replacement image region; step S204, a plurality of first image comprehensive features corresponding to the plurality of first image regions is acquired, wherein the first image comprehensive features at least represent image content information of the corresponding first image regions; step S205, the plurality of first text comprehensive features and the plurality of first image comprehensive features are input into the neural network model together, e.g., simultaneously, to obtain a plurality of first text representation features that correspond to the plurality of first texts and are output by the neural network model, wherein the neural network model is configured to, for each first text in the plurality of first texts, fuse a first text comprehensive feature corresponding to the first text with the plurality of first image comprehensive features so as to generate a first text representation feature corresponding to the first text; step S206, a predicted label is determined based on the plurality of first text representation features, wherein the predicted label indicates a prediction result of whether each first image region of the plurality of first image regions is the replacement image region; and step S207, the neural network model is trained based on the ground truth label and the predicted label.

Thus, the text features of the texts in the document image and the image features of the plurality of regions of the sample document image obtained by replacing the part of regions in the document image are input into the neural network model together, e.g., simultaneously, the text representation output by the model is used to predict a region where the image and the text do not match, and then the model is trained based on the predicted label and the ground truth label, thereby realizing learning of fine-grained text representation combined with image and text information, enhancing interaction between two modalities of the image and the text at the same time, and further improving performance of the neural network model in a downstream task of a document scenario.

Application industries of document image understanding may include: finance, law, insurance, energy, logistics, medical care, etc., and examples of a document may include: a note, a document, a letter, an envelope, a contract, a writ, an official document, a statement, a bill, a prescription, etc. According to requirements of different industries and different application scenarios, a document image understanding task may include, for example, document information extraction, document content analysis, document comparison, etc. It may be understood that document image understanding may further be applied in wider fields and application scenarios, and types of documents are not limited to the above examples as well.

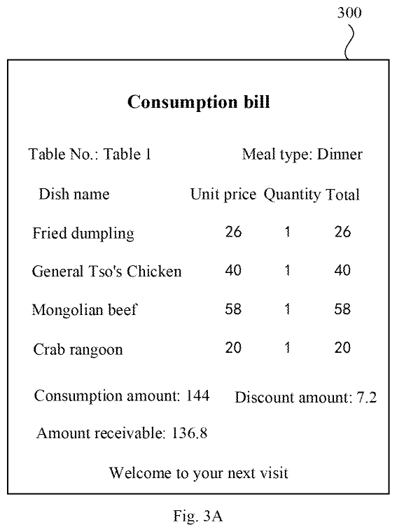

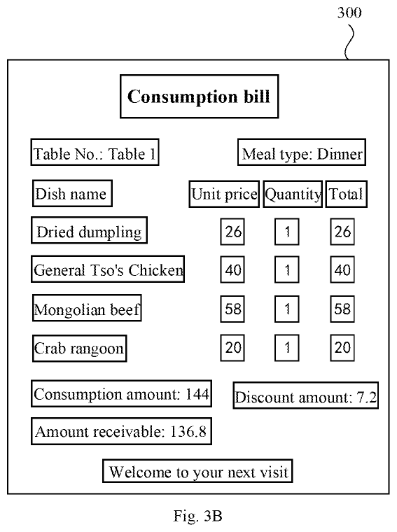

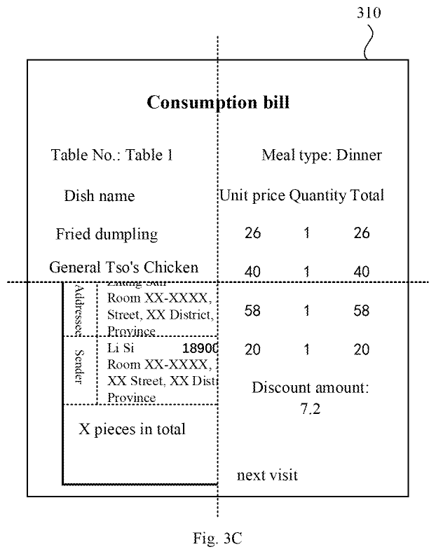

The document image may include electronic, scanned or other forms of images of various types of documents, usually its main content is text, characters, numbers or special symbols, and some types of documents may further have a specific layout. In one example, as shown in FIG. 3A, the document image 300 includes the plurality of texts and has a specific layout arranged regularly.

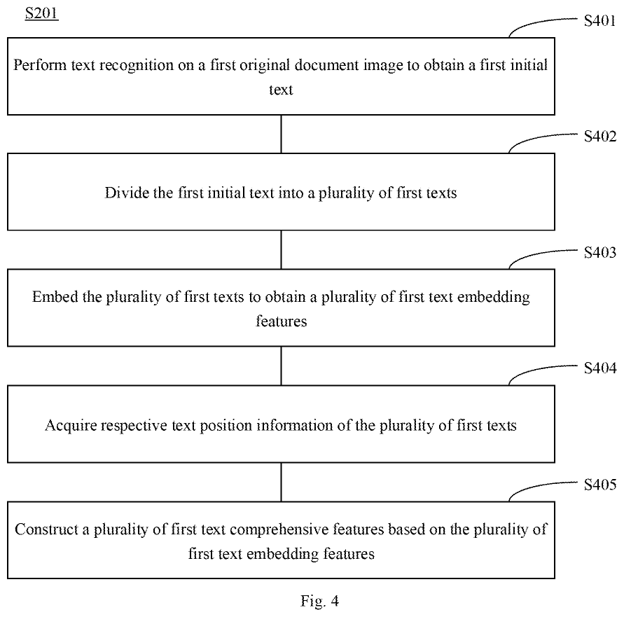

According to some embodiments, as shown in FIG. 4, step S201, acquiring the plurality of first text comprehensive features corresponding to the plurality of first texts in the first original document image may include: step S401, text recognition is performed on the first original document image to obtain a first initial text; step S402, the first initial text is divided into the plurality of first texts; step S403, the plurality of first texts are embedded to obtain a plurality of first text embedding features; and step S405, the plurality of first text comprehensive features is constructed based on the plurality of first text embedding features.

Therefore, by using a text recognition technology, text content (i.e., the first initial text) in the document image can be accurately obtained, then these text content is divided to obtain a plurality of first texts with moderate granularity, these first texts are embedded, and thus the first text embedding features representing the text content information can be obtained to serve as materials for constructing the first text comprehensive features of an input model, so that the neural network model can learn the text content information of each first text. It should be understood that the text content information may be information related to specific content (e.g., a character) of the text. Similarly, the text-related information may further include text position information related to an absolute position or relative position of the text in the document image and unrelated to the text content, as will be described below.

In step S401, for example, OCR may be used to perform text recognition on the first original document image to obtain one or more text paragraphs located at different positions in the first original document image, and these text paragraphs may be referred to as the first initial text.

A result of text recognition may further include a bounding box surrounding these text paragraphs. In one example, as shown in FIG. 3B, by performing text recognition on the document image 300, the plurality of text paragraphs such as a title, dish, price, etc., and the bounding box surrounding these text paragraphs may be obtained. Some attributes of the bounding box (for example, coordinates, shape, size and the like of the bounding box) can be used as position information of the corresponding text paragraph. In some embodiments, these bounding boxes may have regular shapes (such as a rectangle), may also have irregular shapes (such as shapes surrounded by an irregular polygon or an irregular curve). In some embodiments, the coordinates of the bounding box may be represented by coordinates of a center point of a region surrounded by the bounding box, and may also be represented by a plurality of points on the bounding box (for example, part of or all vertices of the rectangle or the irregular polygon, and a plurality of points on the irregular curve). In some embodiments, the size of the bounding box may be represented by a width, height, or both of the bounding box, and may also be represented by an area of the bounding box or an area proportion in the document image. It may be understood that the above description is only illustrative, and those skilled in the art may use other modes to describe the attributes of these bounding boxes, and may also design richer attributes for the bounding boxes to obtain richer text position information, which is not limited here.

In step S402, for example, the above one or more text paragraphs located in different positions may be directly taken as the plurality of first texts to realize division of the first initial text, or a word segmentation algorithm may also be used to split each text paragraph of the first initial text to obtain the first text with moderate granularity. In one example embodiment, the WordPiece algorithm may be used to perform word segmentation on the text paragraphs in a first initial document. It may be understood that those skilled in the art may use other algorithms to perform word segmentation on the text paragraphs in the first initial text, and may also use other modes to divide the first initial text, which is not limited here. In one example, a text paragraph “Welcome to your next visit” in the document image 300 is subjected to word segmentation to obtain three first texts of “Welcome”, “Next” and “Visit”.

In step S403, for example, the first texts may be embedded by using a pre-trained text embedding model to obtain the corresponding first text embedding features. The text embedding model may map the text content information into a low-dimensional feature space, which can significantly reduce dimension of text features compared to a one-hot feature, and can reflect a similarity relationship between the texts. An example of the text embedding model is a word embedding model, which may be trained by using a bag-of-word method or a Skip-Gram method. In some embodiments, the embedding features of a large number of texts may be pre-stored in a vocabulary, so that the first text embedding features corresponding to the first texts can be directly indexed from the vocabulary in step S403.

In some embodiments, after obtaining the plurality of first text embedding features, step S405 may be directly executed to take the first text embedding feature of each first text as the first text comprehensive feature corresponding to the first text, so that the neural network model that receives the first text comprehensive feature representing the text content information in the first text can learn the text content information. In some other embodiments, other information of the first texts may further be fused with the first text embedding features to obtain the first text comprehensive features that can further represent richer information of the first texts.

According to some embodiments, as shown in FIG. 4, step S201, acquiring the plurality of first text comprehensive features corresponding to the plurality of first texts in the first original document image may further include: step S404, respective text position information of the plurality of first texts is acquired.

According to some embodiments, the text position information of the first texts may include first text position information. The first text position information, or referred to as one-dimensional position information, may indicate a reading order of the corresponding first text in the first original document image. The reading order can reflect a logical reading sequence relationship between these first texts.

Thus, by inputting the first text position information indicating the logical reading sequence among the plurality of first texts into the neural network model, the capability of the model to distinguish the different first texts in the document image is improved.

The reading order of the first text may, for example, be determined based on a rule, predetermined or dynamically determined. In one example, the reading order of each first text may be determined based on a predetermined or dynamically determined rule of reading line by line from top to bottom and reading word by word from left to right. The reading order of the first text may, for example, also be determined by using a method such as machine learning for prediction, and may further be determined by other modes, which is not limited here. In some embodiments, a text recognition result for the first original document image obtained in step S401 may include the respective reading order of one or more paragraphs serving as the first initial text, then a reading sequence of the first text in each paragraph may be further determined and combined with the reading order between the paragraphs to obtain the respective reading orders of all the first texts globally (i.e., the first text position information).

In one example, the reading sequence of the plurality of first texts in the document image 300 in FIG. 3A may be, for example: “Consumption”→“Bill”→“Table number”→“:”→“Table 1”→“Meal type”→“:”→“Dinner”→“Dish name”→“Unit price”→“Quantity”→“Total”→“Fried dumpling”→“26”→“1”→“26”→“General Tso's Chicken”→“40”→“1”→“40”→“Mongolian beef”→“58”→“1”→“58”→“Crab rangoon”→“20”→“1”→“20”→“Consumption”→“Amount”→“:”→“144”→“Discount”→“Amount”→“:”→“7.2”→“Amount receivable”→“Amount”→“:”→“136.8”→“Welcome”→“Next”→“Visit”.

According to some embodiments, each first text may be assigned a sequence number representing its reading order, and such sequence number may be directly taken as the first text position information of the first text, or the sequence number may also be embedded to obtain a first text position feature, or other forms may further be used as representation of the first text position information, which is not limited here.

According to some embodiments, the text position information of the first texts may further include second text position information. The second text position information, or referred to as two-dimensional position information, may indicate at least one of a position, shape or size of the corresponding first text in the first original document image. In some embodiments, a position, shape and size of a region covered by the first texts in the image may be used as the second text position information.

Thus, by inputting the second text position information, which indicates the position, shape, size and the like, strongly correlated with the first texts itself, of the first texts in the image and is capable of embodying attributes of relationships such as the position and the size among the plurality of first texts, into the neural network model, the capability of the model to distinguish the different first texts in the document image is improved.

According to some embodiments, the second text position information may indicate at least one of coordinates of a plurality of points on a bounding box surrounding the corresponding first text, a width of the bounding box, or a height of the bounding box. It may be understood that using the position, shape and size of the first texts in the first original document image, and some attributes of the bounding box surrounding the first texts as the second text position information is similar as using some attributes of the bounding box surrounding the text paragraphs as the position information of the text paragraphs above, which is not repeated here.

In one example embodiment, the bounding box surrounding the first texts is a rectangle parallel to an edge of the document image, and the second text position information includes coordinates of upper left and lower right corners of the bounding box as well as the width and height of the bounding box.

According to some embodiments, numerical values such as the coordinates of the points and the width or height of the bounding box may be directly taken as the second text position information, or these numerical values may also be embedded to obtain the second text position feature, or other forms can further be used as representation of the second text position information, which is not limited.

In step S405, for each first text of the plurality of first texts, the text position information of the first text and the first text embedding feature may be fused so as to obtain the first text comprehensive feature corresponding to the first text. In one example embodiment, the first text embedding features, the first text position features, and the second text position features may be directly added to obtain the corresponding first text comprehensive features. It may be understood that those skilled in the art may also use other modes to fuse the text position information of the first texts with the first text embedding features, so as to obtain text comprehensive features that can simultaneously represent the text content information and text position information of the first texts.

Therefore, by fusing the text position information with the text embedding features, the neural network model can distinguish texts in different positions in the document image, and can generate the text representation feature of each text based on the position information of each text and a position relationship among the texts.

After obtaining the plurality of first text comprehensive features corresponding to the plurality of first texts in the first original document image, a first sample document image for a fine-grained image-text matching task may be constructed, and the plurality of first image comprehensive features for being input into the neural network model is further acquired.

In step S202, at least one original image region is determined from among the plurality of original image regions included in the first original document image based on a predetermined or dynamically determined rule. In the description herein, a predetermined rule is used as an illustrative example, which does not limit the scope of the disclosure.

In some embodiments, the plurality of original image regions may be obtained by dividing the first original document image into a uniform rectangular grid having a row number as a third value and a column number as a fourth value, and each original image region is rectangular and has the same size. It may be understood that the larger the third value and the fourth value are, the more the image dividing regions exist, and the more it can help the neural network model to learn the fine-grained multimodal text representation feature, but it will increase training difficulty and occupation of computing resources.

In some embodiments, the plurality of original images may also be determined in the first original document image based on other modes (such as random cropping).

According to some embodiments, the predetermined rule indicates performing random selection among the plurality of original image regions to determine the at least one original image region. Thus, by randomly selecting the original image region needing to be replaced from among the plurality of original image regions, human factors in a process of generating the first sample document image are prevented from interfering with model training.

In some embodiments, the predetermined rule may further indicate selecting an appropriate region for replacement according to relevant information of the original image region (such as, the amount, density, and the like of the texts included in the original image region), thereby improving learning of the multimodal text representation feature. It may be understood that those skilled in the art may design corresponding predetermined rules according to requirements, which is not limited here.

According to some embodiments, each original image region of the plurality of original image regions is selected with a predetermined probability of not greater than 50%. Thus, by setting the corresponding predetermined probability, a probability of each region being selected (i.e., replaced) is less than 50%, so as to ensure that most of the image regions are image-text aligned in most cases, thereby promoting learning of the multimodal text representation feature.

In some embodiments, in step S203, the number of at least one original image region needing to be replaced may be predetermined, and then the at least one original region of the number is determined from among the plurality of original image regions for replacement. In this way, the number of replaced image regions can be guaranteed to be constant.

In some other embodiments, in step S203, a replacement probability may be predetermined, and it is independently determined whether each image region of the plurality of original image regions is replaced based on the replacement probability. In this way, computation complexity can be reduced, but the number of image regions being actually replaced eventually is not constant, and may be more or less based on an expected value of the number of replaced image regions calculated based on the replacement probability. In one example embodiment, both the third value and the fourth value are 7, the number of the original image regions is 49, the replacement probability is set to be 10%, and the expected value of the number of the replaced image regions is approximately equal to 5.

According to some embodiments, the at least one replacement image region is from at least another document image different from the original document image. Thus, by replacing part of the original image region with the document image instead of arbitrary image, the learning capability of the neural network model for text representation can be enhanced. In other words, if an image of an arbitrary scenario is used for replacement, the image may be far from the document scenario (for example, the image includes less text or even does not include any text), so the model may utilize the text representation to predict which regions are replaced without learning sufficiently.

After replacing the at least one original image region, the first sample document image including the plurality of first image regions may be obtained. These first image regions may be in one-to-one correspondence to the plurality of original image regions, and include the at least one replaced image region after replacement and one or more original image regions that are not replaced among the plurality of original image regions. In one example, as shown in FIG. 3A and FIG. 3C, the third value and the fourth value set when determining the original image region of the document image 300 are both 2, and an original image region at the lower left corner of the document image 300 is replaced with the replacement image region from another original document image, so as to obtain a sample image 310.

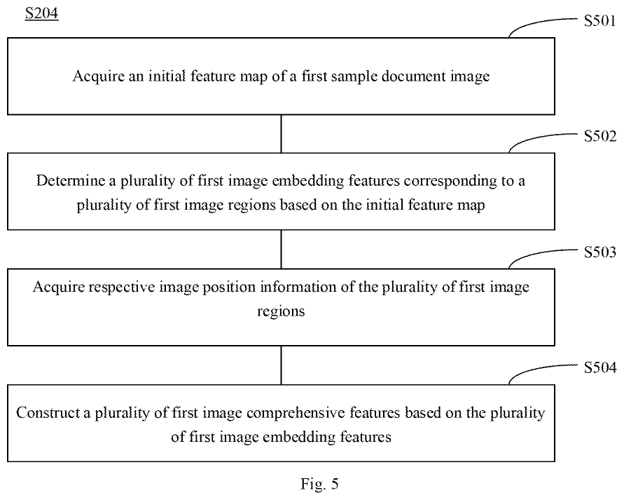

After the replacement is completed, a ground truth label of the fine-grained image-text matching task can further be obtained. The ground truth label may indicate whether each first image region of the plurality of first image regions is the replacement image region. It may be understood that the present disclosure does not limit an expressive form of the ground truth label. In some embodiments, a plurality of dichotomous labels indicating whether each first image region is the replacement image region may be used as the ground truth label, or a list recording an identifier of each replacement image region may also be used as the ground truth label, or other modes may further be used as the expressive form of the ground truth label, which is not limited here. According to some embodiments, as shown in FIG. 5, step S204, acquiring the plurality of first image comprehensive features corresponding to the plurality of first image regions may include: step S501, an initial feature map of the first sample document image is acquired; step S502, a plurality of first image embedding features corresponding to the plurality of first image regions is determined based on the initial feature map; and step S504, the plurality of first image comprehensive features is constructed based on the plurality of first image embedding features.

Thus, by acquiring the initial feature map including all the image content information of the first sample document image, and splitting and fusing pixels in the initial feature map, the first image embedding feature representing the image content information of each first image region can be obtained to serve as a material for constructing the first image comprehensive feature input into the model. The neural network model can learn the image content information of each first image region. It should be understood that the image content information may be information related to specific content (such as a pixel value) in an image or the image region. Similarly, the related information of the image region may further include image position information related to an absolute or relative position of the image region in the original image or the sample image, as will be described below.

In step S501, the first sample document image may be input into a neural network for image feature extraction or image encoding to obtain the initial feature map. In one example embodiment, the initial feature map of the first sample document image may be obtained by using ResNet. It may be understood that those skilled in the art may use other neural networks with image feature extraction or image encoding functions, and may also build a neural network according to requirements, which is not limited here.

According to some embodiments, the plurality of first image regions is obtained by dividing the first sample document image into uniform rectangular grids each having a row number as a first value and a column number as a second value. In some embodiments, the uniform rectangular grid dividing the first sample document image and the uniform rectangular grid dividing the first original document image may be the same, that is, the first value equals to the third value and the second value equals to the fourth value. In this way, the plurality of first image regions and the plurality of original image regions may be in one-to-one correspondence.

According to some embodiments, step S502, determining the plurality of first image embedding features corresponding to the plurality of first image regions based on the initial feature map may include: the initial feature map is mapped into a target feature map with a pixel row number as the first value and a pixel column number as the second value; and a pixel at a corresponding position in the target feature map is determined as the first image embedding feature corresponding to the first image region for each first image region of the plurality of first image regions based on a position of the first image region in the first sample document image.

Therefore, by mapping the initial feature map of the sample document image to the same size as the rectangular grid dividing the first sample document image, a feature vector corresponding to each pixel in the target feature map obtained after mapping may be directly taken as an embedding feature of the first image region corresponding to the pixel in the first sample document image in position.

Such image region division mode and embedding feature determining mode may reduce the computational complexity and resource occupancy of the training process, and meanwhile have a better training effect.

According to some embodiments, mapping the initial feature map into the target feature map with the pixel row number as the first value and the pixel column number as the second value may be implemented by pooling. In one example embodiment, both the first value and the second value are 7, and average pooling may be executed on the initial feature map to obtain the target feature map with both the pixel row number and the pixel column number being 7.

Optionally or additionally, each first image region may be cropped, and the corresponding first image embedding feature may be extracted based on a cropped image; and a pixel of the region corresponding to each first image region in the initial feature map may also be fused (such as average pooled) to obtain the corresponding first image embedding feature. Further, the plurality of embedding features may also be determined for the first image region in various modes, and these features are fused to obtain the first image embedding features for being input into the neural network model.

In some embodiments, after obtaining the plurality of first image embedding features, step S504 may be directly executed to take the first image embedding feature of each first image region as the first image comprehensive feature corresponding to the first image region, so that the neural network model that receives the first image comprehensive feature representing the image content information of the first image region can learn the image content information. In some other embodiments, other information of the first image regions may further be fused with the first image embedding features to obtain the first image comprehensive features that can further represent the richer information of the first image regions.

According to some embodiments, as shown in FIG. 5, step S204, acquiring the plurality of first image comprehensive features corresponding to the plurality of first image regions may further include: step S503, respective image position information of the plurality of first image regions is acquired.

According to some embodiments, the image position information may include at least one of first image position information or second image position information. The first image position information may indicate a browsing order of the corresponding first image region in the first sample document image, and the second image position information may indicate at least one of a position, shape, or size of the corresponding first image region in the first sample document image.

Thus, by inputting the first image position information indicating a browsing sequence among the plurality of first image regions into the neural network model, the capability of the model to distinguish the different first image regions in the document image is improved. While by inputting the second image position information indicating the position, shape, size and the like, strongly correlated with the first image regions itself, of the first image regions in the image and being capable of embodying attributes of relationships such as the position and the size among the plurality of first image regions into the neural network model, the capability of the model to distinguish the different first image regions in the document image is improved.

It may be understood that meaning and generation method of the browsing order of the first image regions are similar to meaning and generation method of the reading order of the text paragraphs in the first texts or the first initial texts, and meaning and acquisition mode of the position, shape and size of the first image regions are similar to meaning and acquisition modes of the position, shape, and size of the bounding box surrounding the first texts or the bounding box surrounding the text paragraphs in the first initial text, which is not be repeated here. In one example, the browsing sequence of the plurality of first image regions in the document image 310 in FIG. 3C may be, for example: upper left region→upper right region→lower left region→lower right region.

In step S504, for each first image region of the plurality of first image regions, the image position information of the first image region and the first image embedding feature are fused so as to obtain the first image comprehensive feature corresponding to the first image region. It may be understood that those skilled in the art may embed the first image position information and the second image position information of the first image region by referring to the above description of the first text position feature and the second text position feature so as to obtain a first image position feature and a second image position feature. In one example embodiment, the first image embedding features, the first image position features, and the second image position features may be directly added to obtain the corresponding first image comprehensive features. It may be understood that those skilled in the art may also use other modes to fuse the image position information of the first image regions with the first image embedding features, so as to obtain image comprehensive features that can together represent the image content information and image position information of the first image regions.

It should be noted that when generating the above first text comprehensive features and first image comprehensive features for being input into the neural network model, these features may be mapped as their hidden dimensions being consistent with dimensions of a hidden layer of the neural network model, so as to meet the input requirements of the model.

In step S205, after obtaining the plurality of first text comprehensive features and the plurality of first image comprehensive features, these features may be input into the neural network model together, e.g., simultaneously, so as to obtain the plurality of first text representation features that correspond to the plurality of first texts and are output by the neural network model.

The neural network models may be applied to a document scenario and may be configured to execute a document image understanding task. According to some embodiments, the neural network model is based on at least one of an ERNIE model or an ERNIE-Layout model, and may be initialized by using ERNIE or ERNIE-Layout.

According to some embodiments, the neural network model may be configured to, for each first text of the plurality of first texts, fuse the first text comprehensive feature corresponding to the first text with the plurality of first image comprehensive features so as to generate the first text representation feature corresponding to the first text. Thus, the neural network can fuse the image information of the image regions with the text information of the text for each received text to obtain a multimodal text representation feature.

The neural network mod may further use an attention mechanism. According to some embodiments, the neural network model may further be configured to, for each input feature in at least one input feature of the plurality of received input features, fuse a plurality of input features based on similarity between the input feature and each input feature of the plurality of input features, so as to obtain an output feature corresponding to input. Thus, by using the attention mechanism, learning of the multimodal text representation feature by the neural network model can be further improved. In one example embodiment, the neural network model may be constructed by using one or more series-connected Transformer structures.

The input of the neural network model may further include special features corresponding to special symbols, as described above.

According to some embodiments, it may be determined that which input features specifically need to be included in at least one input feature of the above plurality of input features according to task requirements. In other words, it may be determined that which representation features of the input features correspond to expected model output according to the task requirements. In one example embodiment, when the above method is executed, the first text representation feature output by the model for the first text comprehensive feature corresponding to each first text input into the model may be acquired, so as to obtain full multimodal text representation features about the first sample document image.

According to some embodiments, step S206, determining the predicted label based on the plurality of first text representation features includes: the plurality of first text representation features is fused to obtain a first text global feature; and the respective predicted label of the plurality of first image regions is determined based on the first text global feature. Thus, by fusing the plurality of first text representation features, global multimodal image-text interaction information can be utilized to predict whether each first image region is a replacement image region, which promotes sufficient learning of the multimodal text representation feature.

In one embodiment, the fusing the plurality of first text representation features may include, for example, executing global pooling on the plurality of first text representation features. It may be understood that other modes may also be used to fuse the plurality of first text representation features, for example, the plurality of first text representation features is spliced, or the plurality of first text representation features is further processed by using a small neural network to obtain the first text global feature, which is not limited here.

In one embodiment, the first text global feature may be processed by using a classifier to obtain a dichotomous result indicating whether each first image region is the replacement image region. It may be understood that other methods may also be used to determine a prediction label capable of indicating a prediction result of whether each first image region of the plurality of first image regions is the replacement image region based on the first text global feature, which is not limited here.

After obtaining the prediction result, a loss value may be determined based on the prediction result and a ground truth result, and then parameters of the neural network model are adjusted according to the loss value. A plurality of epochs of training may be performed on the neural network model until the maximum iteration epoch number is reached or the model converges. In some embodiments, operations such as embedding and feature extraction in the above steps may involve other small neural network models, and parameters of these small neural network models may also be adjusted during a training process, which is not limited here.

To sum up, by executing the above steps, training of the neural network model may be realized, so that the trained neural network model can output a fine-grained multimodal text representation feature combined with image-text information based on the input text comprehensive features and image comprehensive features.

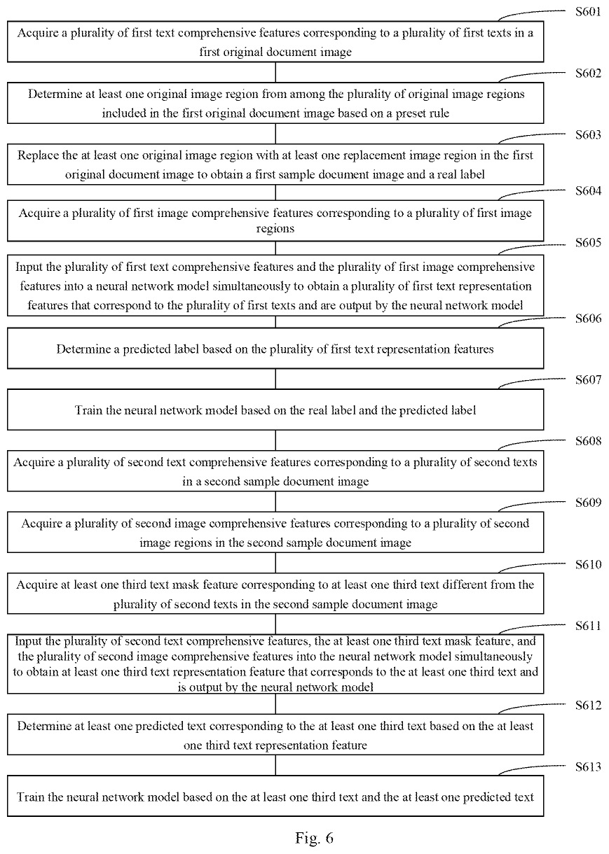

Combination of the above steps S201-S207 may be referred to as a fine-grained matching task. According to some embodiments, as shown in FIG. 6, the training method may further include: step S608, a plurality of second text comprehensive features corresponding to a plurality of second texts in a second sample document image is acquired, wherein the second text comprehensive features represent text content information of the corresponding second texts; step S609, a plurality of second image comprehensive features corresponding to a plurality of second image regions in the second sample document image is acquired, wherein the second image comprehensive features at least represent image content information of the corresponding second image regions; step S610, at least one third text mask feature corresponding to at least one third text different from the plurality of second texts in the second sample document image is acquired, wherein the third text mask feature hides text content information of the corresponding third text; step S611, the plurality of second text comprehensive features, the at least one third text mask feature, and the plurality of second image comprehensive features are input into the neural network model simultaneously to obtain at least one third text representation feature that corresponds to the at least one third text and is output by the neural network model, wherein the neural network model is further configured to, for each third text in the at least one third text, fuse a third text mask feature corresponding to the third text with the plurality of second text comprehensive features and the plurality of second image comprehensive features so as to generate a third text representation feature corresponding to the third text; step S612, at least one predicted text corresponding to the at least one third text is determined based on the at least one third text representation feature, wherein the predicted text indicates a prediction result of the text content information of the corresponding third text; and step S613, the neural network model is trained based on the at least one third text and the at least one predicted text. It may be understood that operations of step S601 to step S607 in FIG. 6 are similar to operations of step S201 to step S207 in FIG. 2, which is not repeated here.

Thus, by using a mask to hide the text content information of part of the text, and using combined image information of the hidden text output by the neural network model and the representation features of the text information of other texts to predict the text, the learning of the fine-grained text representation combined with image-text information is further achieved.

The second sample document image may be another document image that is different from the first original document image and does not execute an operation similar to the replacement operation described in above step S203. The second sample document image may include the plurality of texts.

In some embodiments, before executing step S608, the plurality of texts may be determined in the second sample document image in a mode similar to the operations of above step S401 and step S402. After the plurality of texts is obtained, the plurality of second texts and at least one third text may be determined among the plurality of texts. In one example embodiment, the at least one third text, for example, may be determined by random selection among the plurality of texts. Each text of the plurality of texts may be selected as a third sample with a predetermined probability of not greater than 50%.

According to some embodiments, the third text may be replaced with a mask symbol [mask] for hiding information to hide the text content information of the third text from the neural network model. In some embodiments, the mask symbol [mask] may be embedded to obtain a mask embedding feature, and the mask embedding feature is directly taken as the third text mask feature.

According to some embodiments, the second text comprehensive feature may further represent text position information of the corresponding second text. The third text mask feature may represent text position information of the corresponding third text, and the text position information may include at least one of the third text position information or the fourth text position information. The third text position information may indicate a browsing order of the corresponding text in the second sample document image, and the fourth text position information may indicate at least one of a position, shape, or size of the corresponding text in the second sample document image.

In one example embodiment, a third text position feature and a fourth text position feature representing the text position information of the third text may be determined with reference to the method for acquiring the first text position feature and the second text position feature described above, and the third text position feature, the fourth text position feature and the mask embedding feature are directly added to obtain the third text mask feature.

In some embodiments, the number of the second image comprehensive features (i.e., the number of the plurality of second image regions) input into the neural network model in step S611 may be the same as the number of the first image comprehensive features input into the neural network model in the pre-training task above, so as to improve the learning of the model for the multimodal image-text information (especially image information). Further, the positions, shapes, and sizes of the plurality of second image regions may be similar to or the same as the positions, shapes, and sizes of the plurality of first image regions in the pre-training task above, so as to enhance the learning of the model for the multimodal image-text information related to a specific region.

The combination of the above step S608 to step S613 may be called a mask language model, and the operations of these steps may also refer to the operations of the corresponding steps in the fine-grained matching task, which is not repeated here.

The fine-grained matching task and the mask language model may be the pre-training task for the neural network model for document image understanding, which can help the neural network model understand a fine-grained relationship between words and the images. The neural network model trained by utilizing at least one of the fine-grained matching tasks or the mask language model may be directly configured to execute a downstream task, and may also be subjected to a fine-tuned training to further improve the performance of the neural network, as will be described below.

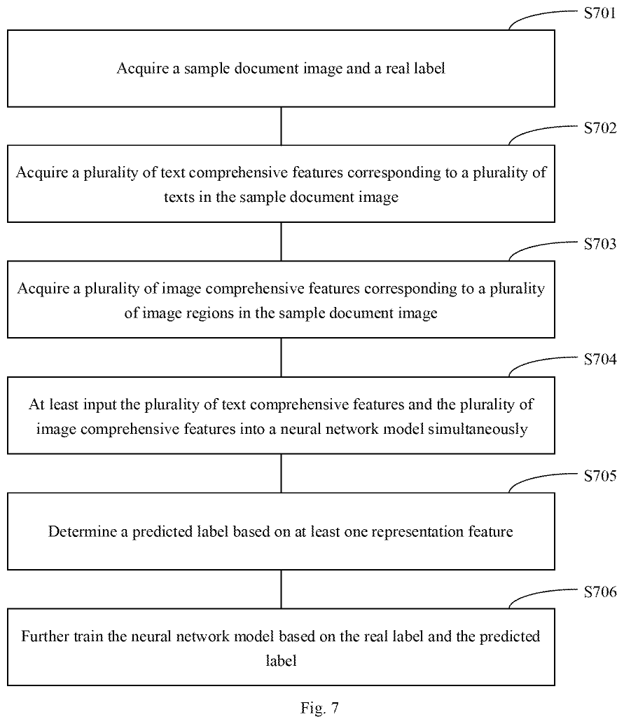

According to an aspect of the present disclosure, a training method of a neural network model for document image understanding is further provided. As shown in FIG. 7, the method includes: step S701, a sample document image and a ground truth label are acquired, wherein the ground truth label indicates an expected result of executing a target document image understanding task on the sample document image; step S702, a plurality of text comprehensive features corresponding to a plurality of texts in the sample document image is acquired, wherein the text comprehensive features at least represent text content information of the corresponding texts; step S703, a plurality of image comprehensive features corresponding to a plurality of image regions in the sample document image is acquired, wherein the image comprehensive features at least represent image content information of the corresponding image regions; step S704, the plurality of text comprehensive features and the plurality of image comprehensive features are at least input into the neural network model simultaneously to obtain at least one representation feature output by the neural network model, wherein the neural network model is obtained by training through any method described above; step S705, a predicted label is determined based on the at least one representation feature, wherein the predicted label indicates an actual result of executing the target document image understanding task on the sample document image; and step S706, the neural network model is further trained based on the ground truth label and the predicted label. It may be understood that the operations of the above step S701 to step S706 may refer to the operations of the corresponding steps in the fine-grained matching task, which is not repeated here.

Thus, by further training the neural network model obtained by training through the above method for a specific target image understanding task, so that a learned fine-grained multimodal image-text matching feature can be more suitable for the specific task, thereby improving the performance of the neural network model during processing of the target image understanding task.

The above training method may also be referred to as the fine-tuning task of the neural network model. Those skilled in the art may design the ground truth label and an input feature input into the neural network model according to the target document image understanding task, so that the trained neural network model can execute the target document image understanding task.

In some embodiments, the input of the neural network model may further include at least one text comprehensive feature corresponding to other texts designed according to the target document image understanding task. In one example, the target document image understanding task is a document visual question answering (DocVQA) task, and the task requires the neural network model to be capable of extracting an answer that can answer a document-related question from a document. By determining a question and expected answer (i.e., ground truth label) related to the sample document image, generating the at least one text comprehensive feature corresponding to the question, then inputting feature and the text comprehensive feature and image comprehensive feature corresponding to the text in the document into the neural network model together, e.g., simultaneously, predicting the answer to the question based on the text representation feature that corresponds to the text in the document and is output by the model, and then training the model according to the answer and the ground truth label, so that the trained model can execute such document visual question answering task.

It should be particularly noted that in step S704, the representation feature output by the neural network model may be a representation feature corresponding to the text comprehensive feature, may also be a representation feature corresponding to the image comprehensive feature, and may further be a representation feature corresponding to a special symbol, which is not limited here.

In some embodiments, the number of the image comprehensive features (i.e., the number of the plurality of image regions) input into the neural network model in step S704 may be the same as the number of the first image comprehensive features input into the neural network model in the pre-training task above, so as to improve the learning of the model for multimodal image-text information (especially image information). Further, positions, shapes, and sizes of the plurality of image regions in a fine-tuned task may be similar to or the same as positions, shapes, and sizes of the plurality of first image regions in the pre-training task above, so as to enhance the learning of the model for multimodal image-text information related to a specific region.

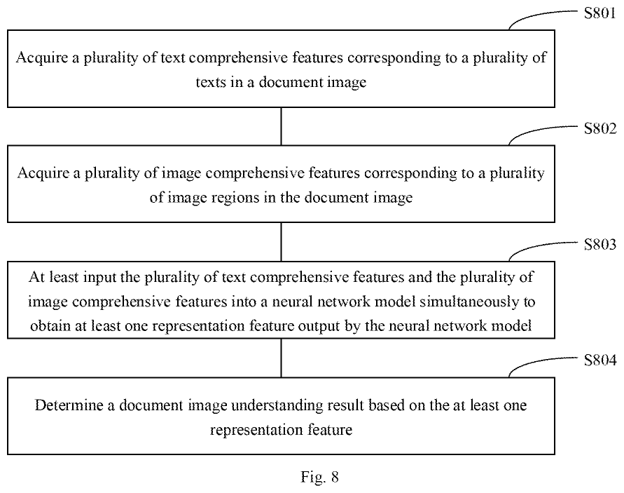

According to an aspect of the present disclosure, a method for document image understanding by utilizing a neural network model is further provided. As shown in FIG. 8, the method includes: step S801, a plurality of text comprehensive features corresponding to a plurality of texts in a document image is acquired, wherein the text comprehensive features at least represent text content information of the corresponding texts; step S802, a plurality of image comprehensive features corresponding to a plurality of image regions in the document image is acquired, wherein the image comprehensive features at least represent image content information of the corresponding image regions; step S803, the plurality of text comprehensive features and the plurality of image comprehensive features are at least input into the neural network model together, e.g., simultaneously, to obtain at least one representation feature output by the neural network model, wherein the neural network model is obtained by training through any method described above; and step S804, a document image understanding result is determined based on the at least one representation feature. It may be understood that the operations of the above step S801 to step S804 may refer to the operations of the corresponding steps in the fine-grained matching task, which is not repeated here.

Thus, by using the neural network model obtained by training through the above method to execute a specific image understanding task, so that a learned fine-grained multimodal image-text matching feature can help a neural network to understand image-text information in the document, thereby improving performance of the neural network model during processing of a specific task.

Those skilled in the art may adjust an input feature input into the neural network model according to the target document image understanding task, so as to utilize the trained neural network model to execute the target document image understanding task. In one example embodiment, the input of the neural network model may further include at least one text comprehensive feature corresponding to a question designed according to the target document image understanding task.

It should be particularly noted that in step S803, the representation feature output by the neural network model may be a representation feature corresponding to the text comprehensive feature, may also be a representation feature corresponding to the image comprehensive feature, and may further be a representation feature corresponding to a special symbol, which is not limited here.

In some embodiments, the number of the image comprehensive features (i.e., the number of the plurality of image regions) input into the neural network model in step S803 may be the same as the number of the first image comprehensive features input into the neural network model in the pre-training task above, so that the model can make full use of learned multimodal image-text information (especially image information) when outputting the representation feature. Further, positions, shapes, and sizes of the plurality of image regions in the document image may be similar to or the same as positions, shapes, and sizes of the plurality of first image regions in the pre-training task above, so as to further improve utilizing of the model for the learned multimodal image-text information related to a specific region.

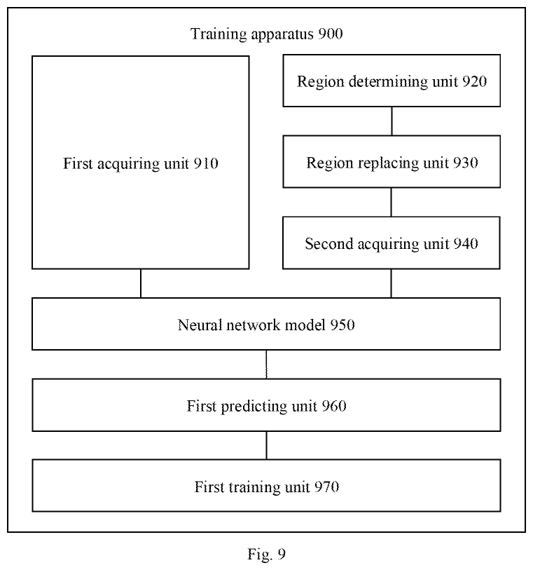

According to an aspect of the present disclosure, a training apparatus of a neural network model for document image understanding is disclosed. As shown in FIG. 9, the training apparatus 900 includes: a first acquiring unit 910, configured to acquire a plurality of first text comprehensive features corresponding to a plurality of first texts in a first original document image, wherein the first text comprehensive features at least represent text content information of the corresponding first texts; a region determining unit 920, configured to determine at least one original image region from among the plurality of original image regions included in the first original document image based on a predetermined rule; a region replacing unit 930, configured to replace the at least one original image region with at least one replacement image region in the first original document image to obtain a first sample document image and a ground truth label, wherein the first sample document image includes a plurality of first image regions, the plurality of first image regions includes the at least one replacement image region and at least another original image region that is not replaced among the plurality of original image regions, wherein the ground truth label indicates whether each first image region of the plurality of first image regions is the replacement image region; a second acquiring unit 940, configured to acquire a plurality of first image comprehensive features corresponding to the plurality of first image regions, wherein the first image comprehensive features at least represent image content information of the corresponding first image regions; the neural network model 950, configured to, for each first text of the plurality of first texts, fuse the received first text comprehensive feature corresponding to the first text with the plurality of received first image comprehensive features so as to generate a first text representation feature corresponding to the first text for outputting; a first predicting unit 960, configured to determine a predicted label based on the plurality of first text representation features, wherein the predicted label indicates a prediction result of whether each first image region of the plurality of first image regions is the replacement image region; and a first training unit 970, configured to train the neural network model based on the ground truth label and the predicted label.

It may be understood that operations and effects of the unit 910 to the unit 970 in the apparatus 900 are similar to operations and effects of step S201 to step S207 in FIG. 2, which is not repeated here.

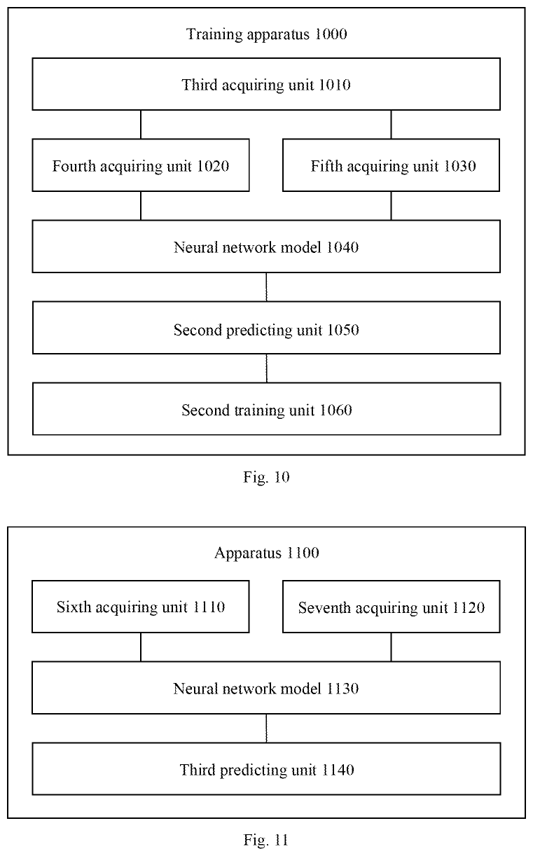

According to an aspect of the present disclosure, a training apparatus of a neural network model for document image understanding is disclosed. As shown in FIG. 10, the training apparatus 1000 includes: a third acquiring unit 1010, configured to acquire a sample document image and a ground truth label, wherein the ground truth label indicates an expected result of executing a target document image understanding task on the sample document image; a fourth acquiring unit 1020, configured to acquire a plurality of text comprehensive features corresponding to a plurality of texts in the sample document image, wherein the text comprehensive features at least represent text content information of the corresponding texts; a fifth acquiring unit 1030, configured to acquire a plurality of image comprehensive features corresponding to a plurality of image regions in the sample document image, wherein the image comprehensive features at least represent image content information of the corresponding image regions; the neural network model 1040, configured to generate at least one representation feature for outputting at least based on the plurality of received text comprehensive features and the plurality of received image comprehensive features, wherein the neural network model is obtained by training through the apparatus 900; a second predicting unit 1050, configured to determine a predicted label based on the at least one representation feature, wherein the predicted label indicates an actual result of executing the target document image understanding task on the sample document image; and a second training unit 1060, configured to further train the neural network model based on the ground truth label and the predicted label.

It may be understood that operations and effects of the unit 1010 to the unit 1060 in the apparatus 1000 are similar to operations and effects of step S701 to step S706 in FIG. 7, which is not repeated here.

According to an aspect of the present disclosure, an apparatus for document image understanding by utilizing a neural network model is disclosed. As shown in FIG. 11, the apparatus 1100 includes: a sixth acquiring unit 1110, configured to acquire a plurality of text comprehensive features corresponding to a plurality of texts in a document image, wherein the text comprehensive features at least represent text content information of the corresponding texts; a seventh acquiring unit 1120, configured to acquire a plurality of image comprehensive features corresponding to a plurality of image regions in the document image, wherein the image comprehensive features at least represent image content information of the corresponding image regions; the neural network model 1130, configured to generate at least one representation feature for outputting at least based on the plurality of received text comprehensive features and the plurality of received image comprehensive features, wherein the neural network model is obtained by training through the apparatus 900 or the apparatus 1000; and a third predicting unit 1140, configured to determine a document image understanding result based on the at least one representation feature.

It may be understood that operations and effects of the unit 1110 to the unit 1140 in the apparatus 1100 are similar to operations and effects of step S801 to step S804 in FIG. 8, which is not repeated here.

In the technical solution of the present disclosure, related processing such as collecting, storing, using, processing, transmitting, providing and disclosing of user personal information all conforms to provisions of relevant laws and regulations, and does not violate public order and moral.

According to embodiments of the present disclosure, an electronic device, a readable storage medium and a computer program product are further provided.

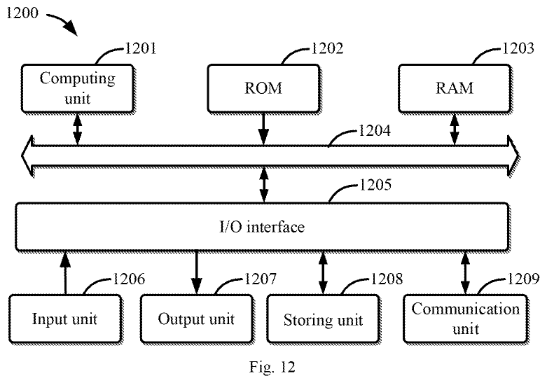

Referring to FIG. 12, a structural block diagram of an electronic device 1200 which can serve as a server or a client of the present disclosure will now be described, which is an example of a hardware device capable of being applied to all aspects of the present disclosure. The electronic device aims to express various forms of digital-electronic computer devices, such as a laptop computer, a desk computer, a work bench, a personal digital assistant, a server, a blade server, a mainframe computer and other proper computers. The electronic device may further express various forms of mobile apparatuses, such as a personal digital assistant, a cellular phone, an intelligent phone, a wearable device and other similar computing apparatuses. Parts shown herein, their connection and relations, and their functions only serve as an example, and are not intended to limit implementation of the present disclosure described and/or required herein.

As shown in FIG. 12, the device 1200 includes a computing unit 1201, which may execute various proper motions and processing according to a computer program stored in a read-only memory (ROM) 1202 or a computer program loaded from a storing unit 1208 to a random access memory (RAM) 1203. In RAM 1203, various programs and data required by operation of the device 1200 may further be stored. The computing unit 1201, ROM 1202 and RAM 1203 are connected with one another through a bus 1204. An input/output (I/O) interface 1205 is also connected to the bus 1204.

A plurality of parts in the device 1200 is connected to the I/O interface 1205, and including: an input unit 1206, an output unit 1207, the storing unit 1208 and a communication unit 1209. The input unit 1206 may be any type of device capable of inputting information to the device 1200, the input unit 1206 may receive input digital or character information, and generates key signal input relevant to user setting and/or functional control of the electronic device, and may include but not limited to a mouse, a keyboard, a touch screen, a trackpad, a trackball, an operating lever, a microphone and/or a remote control. The output unit 1207 may be any type of device capable of presenting information, and may include but not limited to a display, a loudspeaker, a video/audio output terminal, a vibrator and/or a printer. The storing unit 1208 may include but not limited to a magnetic disc and an optical disc. The communication unit 1209 allows the device 1200 to exchange information/data with other devices through a computer network such as Internet and/or various telecommunication networks, and may include but not limited to a modem, a network card, an infrared communication device, a wireless communication transceiver and/or a chip set, such as a Bluetooth™ device, a 802.11 device, a WiFi device, a WiMax device, a cellular communication device and/or analogues.

The computing unit 1201 may be various general and/or dedicated processing components with processing and computing capabilities. Some examples of the computing unit 1201 include but not limited to a central processing unit (CPU), a graphic processing unit (GPU), various dedicated artificial intelligence (AI) computing chips, various computing units running a machine learning model algorithm, a digital signal processor (DSP), and any proper processor, controller, microcontroller, etc. The computing unit 1201 executes various methods and processes described above, for example the pre-training method of the neural network model for document image understanding and the method for document image understanding by utilizing the neural network model. For example, in some embodiments, the pre-training method of the neural network model for document image understanding and the method for document image understanding by utilizing the neural network model may be implemented as a computer software program, which is tangibly contained in a machine-readable medium, such as the storing unit 1208. In some embodiments, part or all of the computer program may be loaded into and/or mounted on the device 1200 via the ROM 1202 and/or the communication unit 1209. When the computer program is loaded to the RAM 1203 and executed by the computing unit 1201, one or more steps of the pre-training method of the neural network model for document image understanding and the method for document image understanding by utilizing the neural network model described above may be executed. Alternatively, in other embodiments, the computing unit 1201 may be configured to execute the pre-training method of the neural network model for document image understanding and the method for document image understanding by utilizing the neural network model through any other proper modes (for example, by means of firmware).

Various implementations of the systems and technologies described above in this paper may be implemented in a digital electronic circuit system, an integrated circuit system, a field programmable gate array (FPGA), an application specific integrated circuit (ASIC), an application specific standard part (ASSP), a system on chip (SOC), a complex programmable logic device (CPLD), computer hardware, firmware, software and/or their combinations. These various implementations may include: being implemented in one or more computer programs, wherein the one or more computer programs may be executed and/or interpreted on a programmable system including at least one programmable processor, and the programmable processor may be a special-purpose or general-purpose programmable processor, and may receive data and instructions from a storage system, at least one input apparatus, and at least one output apparatus, and transmit the data and the instructions to the storage system, the at least one input apparatus, and the at least one output apparatus.

Program codes for implementing the methods of the present disclosure may be written in any combination of one or more programming languages. These program codes may be provided to processors or controllers of a general-purpose computer, a special-purpose computer or other programmable data processing apparatuses, so that when executed by the processors or controllers, the program codes enable the functions/operations specified in the flow diagrams and/or block diagrams to be implemented. The program codes may be executed completely on a machine, partially on the machine, partially on the machine and partially on a remote machine as a separate software package, or completely on the remote machine or server.

In the context of the present disclosure, a machine readable medium may be a tangible medium that may contain or store a program for use by or in connection with an instruction execution system, apparatus or device. The machine readable medium may be a machine readable signal medium or a machine readable storage medium. The machine readable medium may include but not limited to an electronic, magnetic, optical, electromagnetic, infrared, or semiconductor system, apparatus or device, or any suitable combination of the above contents. More specific examples of the machine readable storage medium will include electrical connections based on one or more lines, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the above contents.

In order to provide interactions with users, the systems and techniques described herein may be implemented on a computer, and the computer has: a display apparatus for displaying information to the users (e.g., a CRT (cathode ray tube) or LCD (liquid crystal display) monitor); and a keyboard and a pointing device (e.g., a mouse or trackball), through which the users may provide input to the computer. Other types of apparatuses may further be used to provide interactions with users; for example, feedback provided to the users may be any form of sensory feedback (e.g., visual feedback, auditory feedback, or tactile feedback); an input from the users may be received in any form (including acoustic input, voice input or tactile input).

The systems and techniques described herein may be implemented in a computing system including background components (e.g., as a data server), or a computing system including middleware components (e.g., an application server) or a computing system including front-end components (e.g., a user computer with a graphical user interface or a web browser through which a user may interact with the implementations of the systems and technologies described herein), or a computing system including any combination of such background components, middleware components, or front-end components. The components of the system may be interconnected by digital data communication (e.g., a communication network) in any form or medium. Examples of the communication network include: a local area network (LAN), a wide area network (WAN) and the Internet.

A computer system may include a client and a server. The client and the server are generally away from each other and usually interact through the communication network. A relationship of the client and the server is generated through computer programs run on a corresponding computer and mutually having a client-server relationship. The server may be a cloud server, also referred to as a cloud computing server or a cloud host, and is a host product in a cloud computing service system to solve defects of difficult management and weak business expansion in a traditional physical host and VPS (“Virtual Private Server”, or “VPS” for short) service. The server may also be a server of a distributed system, or a server in combination with a blockchain.

It should be understood that various forms of flows shown above may be used to reorder, increase or delete the steps. For example, all the steps recorded in the present disclosure may be executed in parallel, and may also be executed sequentially or in different sequences, as long as the expected result of the technical solution disclosed by the present disclosure may be implemented, which is not limited herein.

Although the embodiments or examples of the present disclosure have been described with reference to the accompanying drawings, it should be understood that the above method, system and device is only an example embodiment or an example, and the scope of the present disclosure is not limited by these embodiments or examples, but only limited by the authorized claim and equivalent scope thereof. Various elements in the embodiments or the examples may be omitted or may be replaced with their equivalent elements. In addition, all the steps may be executed through the sequence different from that described in the present disclosure. Further, various elements in the embodiments or the examples may be combined in various modes. It is important that with evolution of the technology, many elements described here may be replaced with the equivalent element appearing after the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of training a neural network model for document image understanding, comprising:
acquiring a plurality of first text comprehensive features corresponding to a plurality of first texts in a first original document image, wherein each first text comprehensive feature of the plurality of first text comprehensive features at least represent text content information of a corresponding first text of the plurality of first texts;
determining at least one original image region from among a plurality of original image regions comprised in the first original document image based on a rule;
replacing the at least one original image region with at least one replacement image region in the first original document image to obtain a first sample document image and a ground truth label, wherein the first sample document image comprises a plurality of first image regions, the plurality of first image regions comprise the at least one replacement image region and at least another original image region that is not replaced among the plurality of original image regions, wherein the ground truth label indicates whether each first image region of the plurality of first image regions is a replacement image region;
acquiring a plurality of first image comprehensive features corresponding to the plurality of first image regions, wherein each first image comprehensive feature of the plurality of first image comprehensive features at least represent image content information of a corresponding first image region of the plurality of first image regions;
inputting the plurality of first text comprehensive features and the plurality of first image comprehensive features into a neural network model together to obtain a plurality of first text representation features that correspond to the plurality of first texts and are output by the neural network model through artificial intelligence, wherein the neural network model is configured to, for each first text in the plurality of first texts, fuse a first text comprehensive feature corresponding to the first text with the plurality of first image comprehensive features to generate a first text representation feature corresponding to the first text;
determining a predicted label based on the plurality of first text representation features, wherein the predicted label indicates a prediction result of whether each first image region of the plurality of first image regions is a replacement image region; and
training the neural network model based on the ground truth label and the predicted label.

2. The method according to claim 1, wherein the acquiring the plurality of first text comprehensive features corresponding to the plurality of first texts in the first original document image comprises:
performing text recognition on the first original document image to obtain a first initial text;
dividing the first initial text into the plurality of first texts;
embedding the plurality of first texts to obtain a plurality of first text embedding features; and
constructing the plurality of first text comprehensive features based on the plurality of first text embedding features.

3. The method according to claim 2, wherein the acquiring the plurality of first text comprehensive features corresponding to the plurality of first texts in the first original document image comprises:
acquiring text position information for each first text of the plurality of first texts; and
wherein the constructing the plurality of first text comprehensive features based on the plurality of first text embedding features comprises:
for each first text of the plurality of first texts, fusing the text position information of the first text and the first text embedding feature to obtain the first text comprehensive feature corresponding to the first text.

4. The method according to claim 3, wherein the text position information comprises first text position information, and the first text position information indicates a reading order of a corresponding first text in the first original document image.

5. The method according to claim 3, wherein the text position information comprises second text position information, and the second text position information indicates at least one of a position, a shape or a size of a corresponding first text in the first original document image.

6. The method according to claim 5, wherein the second text position information indicates at least one of coordinates of a plurality of points on a bounding box surrounding the corresponding first text, a width of the bounding box, and a height of the bounding box.

7. The method according to claim 1, wherein the at least one replacement image region is obtained from at least one another document image different from the original document image.

8. The method according to claim 1, wherein the rule indicates performing random selection among the plurality of original image regions to determine the at least one original image region.

9. The method according to claim 8, wherein each original image region of the plurality of original image regions has a predetermined probability of not greater than 50% to be selected.

10. The method according to claim 1, wherein the acquiring the plurality of first image comprehensive features corresponding to the plurality of first image regions comprises:
acquiring an initial feature map of the first sample document image;
determining a plurality of first image embedding features corresponding to the plurality of first image regions based on the initial feature map; and
constructing the plurality of first image comprehensive features based on the plurality of first image embedding features.

11. The method according to claim 10, wherein the plurality of first image regions is obtained by dividing the first sample document image into uniform rectangular grids each having a row number as a first value and a column number as a second value,
wherein, determining the plurality of first image embedding features corresponding to the plurality of first image regions based on the initial feature map comprises:
mapping the initial feature map into a target feature map with a pixel row number as the first value and a pixel column number as the second value; and
determining a pixel at a corresponding position in the target feature map as the first image embedding feature corresponding to the first image region for each first image region of the plurality of first image regions based on a position of the first image region in the first sample document image.

12. The method according to claim 10, wherein the acquiring the plurality of first image comprehensive features corresponding to the plurality of first image regions further comprises:
acquiring an image position information of each first image region of the plurality of first image regions; and
wherein the constructing the plurality of first image comprehensive features based on the plurality of first image embedding features comprises:
for each first image region of the plurality of first image regions, fusing the image position information of the first image region and the first image embedding feature to obtain a first image comprehensive feature corresponding to the first image region.

13. The method according to claim 12, wherein the image position information comprises at least one of first image position information and second image position information, the first image position information indicates a browsing order of the corresponding first image region in the first sample document image, and the second image position information indicates at least one of a position, a shape, and a size of a corresponding first image region in the first sample document image.

14. The method according to claim 1, wherein the determining the predicted label based on the plurality of first text representation features comprises:
fusing the plurality of first text representation features to obtain a first text global feature; and
determining the predicted label based on the first text global feature.

15. The method according to claim 1, further comprising:
acquiring a plurality of second text comprehensive features corresponding to a plurality of second texts in a second sample document image, wherein each second text comprehensive feature of the plurality of second text comprehensive features represent text content information of a corresponding second text of the plurality of second texts;
acquiring a plurality of second image comprehensive features corresponding to a plurality of second image regions in the second sample document image, wherein each second image comprehensive feature of the plurality of second image comprehensive features at least represent image content information of a corresponding second image region of the plurality of second image regions;
acquiring at least one third text mask feature corresponding to at least one third text different from the plurality of second texts in the second sample document image, wherein the third text mask feature hides text content information of the corresponding third text;
inputting the plurality of second text comprehensive features, the at least one third text mask feature, and the plurality of second image comprehensive features into the neural network model simultaneously to obtain at least one third text representation feature that corresponds to the at least one third text and is output by the neural network model, wherein the neural network model is further configured to, for each third text in the at least one third text, fuse a third text mask feature corresponding to the third text with the plurality of second text comprehensive features and the plurality of second image comprehensive features to generate a third text representation feature corresponding to the third text;
determining at least one predicted text corresponding to the at least one third text based on the at least one third text representation feature, wherein the predicted text indicates a prediction result of the text content information of the corresponding third text; and
training the neural network model based on the at least one third text and the at least one predicted text.

16. The method according to claim 15, wherein the second text comprehensive features further represent text position information of the corresponding second texts, the third text mask feature represents text position information of the corresponding third text, and wherein the text position information comprises at least one of third text position information and fourth text position information, the third text position information indicates a reading order of the corresponding text in the second sample document image, and the fourth text position information indicates at least one of a position, a shape, and a size of a corresponding text in the second sample document image.

17. The method according to claim 1, wherein the neural network model is configured to, for an input feature of a plurality of received input features, fuse the plurality of input features based on similarity between the input feature and each input feature of the plurality of input features, to obtain an output feature corresponding to the input feature.

18. The method according to claim 1, wherein the neural network model is based on at least one of an ERNIE model or an ERNIE-Layout model.

19. A method of training a neural network model for document image understanding, comprising:
acquiring a sample document image and a ground truth label, wherein the ground truth label indicates an expected result of executing a target document image understanding task on the sample document image;
acquiring a plurality of text comprehensive features corresponding to a plurality of texts in the sample document image, wherein each text comprehensive feature of the plurality of text comprehensive features at least represent text content information of a corresponding text of the plurality of texts;
acquiring a plurality of image comprehensive features corresponding to a plurality of image regions in the sample document image, wherein each image comprehensive feature of the plurality of image comprehensive features at least represent image content information of a corresponding image region of the plurality of image regions;
at least inputting the plurality of text comprehensive features and the plurality of image comprehensive features into a neural network model together to obtain at least one representation feature output by the neural network model through artificial intelligence, wherein the neural network model is obtained by:
acquiring a plurality of first text comprehensive features corresponding to a plurality of first texts in a first original document image, wherein each first text comprehensive feature of the plurality of first text comprehensive features at least represent text content information of a corresponding first text of the plurality of first texts;
determining at least one original image region from among a plurality of original image regions comprised in the first original document image based on a rule;
replacing the at least one original image region with at least one replacement image region in the first original document image to obtain a first sample document image and a ground truth label, wherein the first sample document image comprises a plurality of first image regions, the plurality of first image regions comprise the at least one replacement image region and at least one another original image region that is not replaced among the plurality of original image regions, wherein the ground truth label indicates whether each first image region of the plurality of first image regions is the replacement image region;
acquiring a plurality of first image comprehensive features corresponding to the plurality of first image regions, wherein each first image comprehensive feature of the plurality of first image comprehensive features at least represent image content information of a corresponding first image region of the plurality of first image regions;
inputting the plurality of first text comprehensive features and the plurality of first image comprehensive features into the neural network model together to obtain through artificial intelligence a plurality of first text representation features that correspond to the plurality of first texts and are output by the neural network model, wherein the neural network model is configured to, for each first text in the plurality of first texts, fuse a first text comprehensive feature corresponding to the first text with the plurality of first image comprehensive features to generate a first text representation feature corresponding to the first text;
determining a predicted label based on the plurality of first text representation features, wherein the predicted label indicates a prediction result of whether each first image region of the plurality of first image regions is the replacement image region; and
training the neural network model based on the ground truth label and the predicted label;
determining a predicted label based on the at least one representation feature, wherein the predicted label indicates an actual result of executing the target document image understanding task on the sample document image; and
further training the neural network model based on the ground truth label and the predicted label.

20. A method for understanding document image by utilizing a neural network model, comprising:
acquiring a plurality of text comprehensive features corresponding to a plurality of texts in a document image, wherein each text comprehensive feature of the plurality of text comprehensive features at least represent text content information of a corresponding text of the plurality of texts;
acquiring a plurality of image comprehensive features corresponding to a plurality of image regions in the document image, wherein each image comprehensive feature of the plurality of image comprehensive features at least represent image content information of a corresponding image region of the plurality of image regions;
at least inputting the plurality of text comprehensive features and the plurality of image comprehensive features into the neural network model together to obtain at least one representation feature output by the neural network model, wherein the neural network model is obtained by:
acquiring a plurality of first text comprehensive features corresponding to a plurality of first texts in a first original document image, wherein each first text comprehensive feature of the plurality of first text comprehensive features at least represent text content information of a corresponding first text of the plurality of first texts;
determining at least one original image region from among a plurality of original image regions comprised in the first original document image based on a rule;
replacing the at least one original image region with at least one replacement image region in the first original document image to obtain a first sample document image and a ground truth label, wherein the first sample document image comprises a plurality of first image regions, the plurality of first image regions comprise the at least one replacement image region and at least another original image region that is not replaced among the plurality of original image regions, wherein the ground truth label indicates whether each first image region of the plurality of first image regions is the replacement image region;
acquiring a plurality of first image comprehensive features corresponding to the plurality of first image regions, wherein each first image comprehensive feature of the plurality of first image comprehensive features at least represent image content information of a corresponding first image region of the plurality of first image regions;
inputting the plurality of first text comprehensive features and the plurality of first image comprehensive features into a neural network model together to obtain through artificial intelligence a plurality of first text representation features that correspond to the plurality of first texts and are output by the neural network model, wherein the neural network model is configured to, for each first text in the plurality of first texts, fuse a first text comprehensive feature corresponding to the first text with the plurality of first image comprehensive features to generate a first text representation feature corresponding to the first text;
determining a predicted label based on the plurality of first text representation features, wherein the predicted label indicates a prediction result of whether each first image region of the plurality of first image regions is the replacement image region; and
training the neural network model based on the ground truth label and the predicted label; and
determining a document image understanding result based on the at least one representation feature.
